(19) United States
(12) Patent Application Publication
(10) Pub. No.: US 2013/0328667 A1
(43) Pub. Date: Dec. 12, 2013

(54) REMOTE INTERACTION WITH SIRI

(71) Applicant: Apple Inc., Cupertino, CA (US)

(72) Inventors: Aarti Kumar, San Jose, CA (US); Brian J. Tucker, San Jose, CA (US)

(21) Appl. No.: 13/852,697

(22) Filed: Mar. 28, 2013

Related U.S. Application Data
(60) Provisional application No. 61/657,822, filed on Jun. 10, 2012.

(51) Int. Cl. G08C 17/02

(52) U.S. Cl. CPC G08C 17/02
USPC 340/12.5

(57) ABSTRACT

An electronic device is described. When this electronic device receives a command from another electronic device via a connection using an interface circuit on the electronic device, the electronic device provides the command from the interface circuit to a program module that executes on the portable electronic device, and the program module executes the command. The command may include: starting an application on the electronic device, turning off the application, and/or transitioning the application to a modified presentation operation mode. In this way, the other electronic device may remotely interact with the application on the electronic device.

### CROSS REFERENCE TO RELATED APPLICATION

This application claims priority under 35 U.S.C. §119(e) to U.S. Provisional Application Ser. No. 61/657,822, entitled “Remote Interaction with Siri,” by Aarti Kumar and Brian J. Tucker, Attorney docket number APL-P15454USP1, filed on Jun. 10, 2012, the contents of which is herein incorporated by reference.

### BACKGROUND

1. Field

The described embodiments relate to techniques for remotely interacting with an application on an electronic device.

2. Related Art

The increasing functionality of electronic devices, such as cellular telephones, is leading to a significant increase in their popularity. In turn, these trends are leading to an increase in the number and types of software applications that are available for use on these electronic devices. One recent type of popular software application is an intelligent personal assistant and knowledge manager, such as Siri (from Apple Inc. of Cupertino, Calif.).

In addition, many modern electronic devices include a networking subsystem that is used to wirelessly communicate with other electronic devices. For example, these electronic devices can include a networking subsystem with a cellular network interface (UMTS, LTE, etc.), a wireless local area network interface (e.g., a wireless network such as described in the Institute of Electrical and Electronics Engineers (IEEE) standards 802.11 or Bluetooth™ from the Bluetooth Special Interests Group of Kirkland, Wash.), and/or another type of wireless interface.

However, it can be difficult to seamlessly integrate the wireless communication capabilities of these electronic devices with the software applications that execute on the electronic devices. As a consequence, it can be difficult for one electronic device to provide instructions or commands to another electronic device, which are then correctly interpreted and executed by a software application executing on the other electronic device. This constraint can limit the interactions between electronic devices and software applications, which can frustrate users and degrade the user experience.

### SUMMARY

The described embodiments include an electronic device. This electronic device includes: an antenna; an interface circuit, coupled to the antenna, that communicates with another electronic device; a processor coupled to the interface circuit; and memory that stores an application and a program module that are executed by the processor. The program module facilitates remote interaction between the other electronic device and the application. In particular, when the program module receives a command from the interface circuit, which in turn was received from the other electronic device via the connection, the program module executes the command. This command includes: starting the application, turning off the application, and/or transitioning the application to a modified presentation operation mode.

Note that the application may include an intelligent personal assistant and knowledge manager, such as Siri.

In some embodiments, the electronic device includes a display and, in the modified presentation operation mode, the application limits information presented on display. Moreover, the connection may use a Bluetooth™ communication protocol.

Furthermore, the program module may receive configuration information from the interface circuit, which in turn was received by the interface circuit from the other electronic device via the connection. This configuration information may include a noise-reduction status of information communicated by the other electronic device via the connection. Based on the received configuration status and/or a performance of the connection (such as an error rate), the program module may provide a modification to the configuration information to the interface circuit for transmission to the other electronic device.

Note that the electronic device may include a portable electronic device.

Another embodiment provides a computer-program product for use with the electronic device. This computer-program product includes instructions for at least some of the operations performed by the electronic device.

Another embodiment provides a method for remote interaction between electronic devices, which may be performed by the electronic device. During operation, the electronic device receives the command from the other electronic device via the connection using the interface circuit on the electronic device, where the command includes: starting an application on the electronic device, turning off the application, and/or transitioning the application to the modified presentation operation mode. Then, the electronic device provides the command from the interface circuit to the program module, and executes the command.

### BRIEF DESCRIPTION OF THE FIGURES

FIG. 1 is a block diagram illustrating electronic devices wirelessly communicating in accordance with an embodiment of the present disclosure.

FIG. 2 is a flow diagram illustrating a method for remote interaction between electronic devices in accordance with an embodiment of the present disclosure.

FIG. 3 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

To facilitate interaction between a software application executing in the environment of an electronic device, such as a smartphone, and another electronic device, such as an accessory (for example, an earpiece), commands and information may be exchanged between the electronic device and the other electronic device. In particular, the commands and information may be communicated in packets via a communication channel using wireless communication. For example, the packets in the communication channel may be conveyed using a carrier frequency that is transmitted and received by radios in the electronic devices in accordance with a communication protocol, such as Bluetooth™ (which is used as an illustrative example in the discussion that follows). Furthermore, the commands and the information may be interpreted by program modules that execute on the electronic devices (e.g., a processor subsystem that executes the program module on the electronic device may perform or execute a received command), which then interact with the software application. In the discussion that follows, Siri, and more generally an intelligent personal assistant and knowledge manager, is used as an illustrative example of the software application.

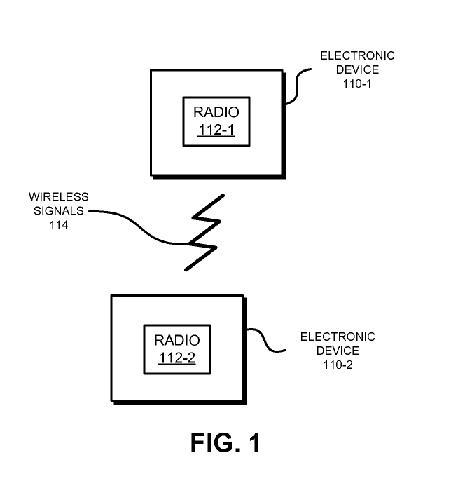

The communication between the electronic devices is shown in FIG. 1, which presents a block diagram illustrating electronic devices 110 wirelessly communicating. In particular, these electronic devices may wirelessly communicate while: discovering one another by scanning wireless channels, transmitting and receiving advertising frames on wireless channels, establishing connections (for example, by transmitting connect requests), and/or transmitting and receiving packets (which may include the commands and/or the information as payloads).

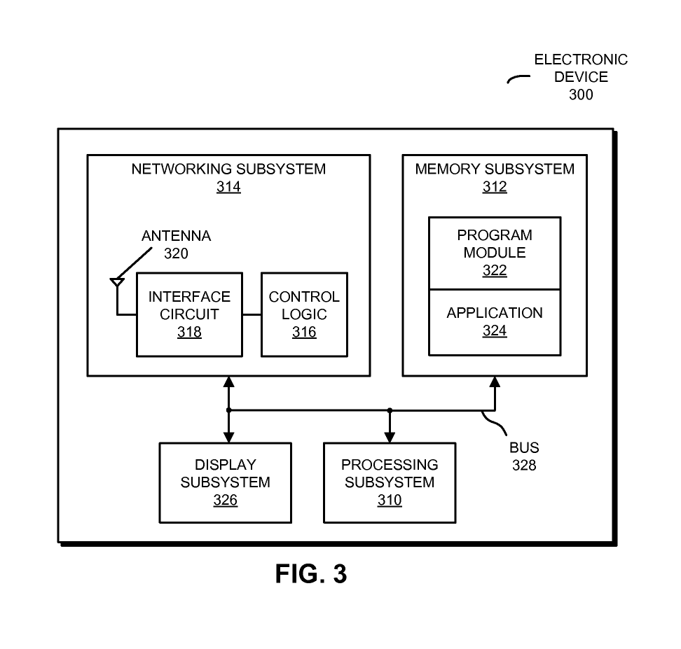

As described further below with reference to FIGS. 3, each of electronic devices 110 may include subsystems, such as a networking subsystem, a memory subsystem and a processor subsystem. In addition, electronic devices 110 may include radios 112 in the networking subsystems. More generally, electronic devices 110 can include (or can be included within) any electronic devices with the networking subsystems that enable electronic devices 110 to wirelessly communicate with another electronic device. This can comprise transmitting advertising frames on wireless channels to enable electronic devices to make initial contact, followed by exchanging subsequent data/management frames (such as connect requests) to establish a connection, configure security options (e.g., IPSEC), transmit and receive packets or frames via the connection, etc.

As can be seen in FIG. 1, wireless signals 114 (represented by jagged lines) are transmitted from a radio 112-1 in electronic device 110-1. These wireless signals 114 are received by radio 112-2 in electronic device 110-2.

In the described embodiments, processing a packet or frame in either of electronic devices 110-1 and 110-2 includes: receiving wireless signals 114 with the packet or frame; decoding/extracting the packet or frame from received wireless signals 114 to acquire the packet or frame; and processing the packet or frame to determine information contained in the packet or frame (such as the command or the information in the payload).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

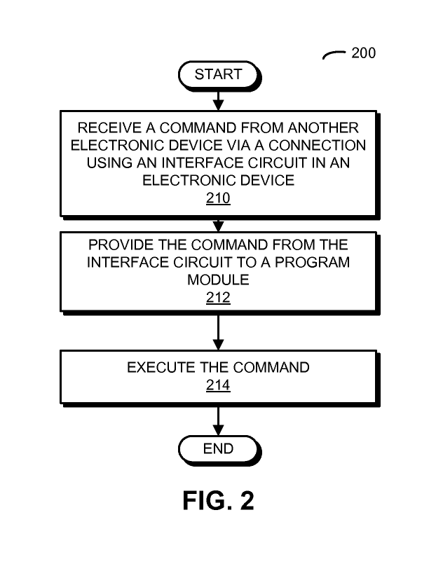

FIG. 2 presents a flow diagram illustrating a method 200 for remote interaction between electronic devices, which may be performed by an electronic device, such as electronic device 300 (FIG. 3). During operation, the electronic device receives the command from the other electronic device via a connection using an interface circuit on the electronic device (operation 210), where the command includes: starting an application (such as Ski) on the electronic device, turning off the application, and/or transitioning the application to a modified presentation operation mode. Then, the electronic device provides the command from the interface circuit to a program module (operation 212), and executes the command (operation 214) using the program module.

As described below with reference to FIG. 3, in some embodiments the electronic device includes a display and, in the modified presentation operation mode, the application limits information presented on the display.

Furthermore, the program module may receive configuration information from the interface circuit, which in turn was received by the interface circuit from the other electronic device via the connection. This configuration information may include a noise-reduction status of information communicated by the other electronic device via the connection. Based on the received configuration status and/or a performance of the connection (such as an error rate), the program module may provide a modification to the configuration information to the interface circuit for transmission to the other electronic device.

Therefore, in some embodiments the other electronic device may receive audio (sound) from a user that specifies or corresponds to a command or information, either directly or indirectly, and which is conveyed to the electronic device via the connection. For example, a user of the other electronic device may press a physical button or an icon on a display (such as a virtual icon on a touchscreen or display) on the other electronic device. In response to the user activating the button, the other electronic device may transmit a command to the electronic device. After receiving this command, the program module may launch Siri. Then, the user of the other electronic device may verbally provide a query. This query may be provided by the other electronic device to the electronic device, where it is processed by Siri and a response is provided (for example, as information on a display and/or the form of an audio signal output by the electronic device). Note that the user's spoken query may be processed using voice recognition. This processing may occur on: the other electronic device, the electronic device, and/or in a remote server coupled to the electronic device (for example, in a client-server architecture).

In these ways, the program module may facilitate remote interaction between the other electronic device and the application, thereby reducing user frustration and improving the user experience, which may improve sales of the electronic device and/or the application, as well as customer retention.

In some embodiments of method 200, there may be additional or fewer operations. Moreover, the order of the operations may be changed, and/or two or more operations may be combined into a single operation.

In an exemplary embodiment, method 200 allows a Bluetooth™ accessory (such as electronic device 110-2) to remotely access the functionality of Siri, which executes in an environment (including an operating system, such as iOS from Apple Inc. of Cupertino, Calif.) of the electronic device (such as electronic device 110-1 in FIG. 1). For example, the electronic device may include an iPhone (from Apple Inc. of Cupertino, Calif.).

Referring back to FIG. 1, we now describe a series of commands and associated formats that may be supported by the program module to facilitate remote interaction between electronic devices 110. Electronic device 110-2 may support a hands-free profile (HFP) command AT+XAPL to provide accurate information about its supported features. When electronic device 110-1 receives this command and the associated information, it may be used by the program module to enable/disable custom Siri-related commands.

The format of this command is AT+XAPL=[vendor identifier]-[product identifier]-[version]-[features], where the command parameters include: the vendor identifier (such as a string representation of the value of the vendor identifier from the manufacturer), the product identifier (such as a string representation of the value of the product identifier from the manufacturer), the version (i.e., the software revision), and the features (such as a representation of a bit field). Note that values of the features may include: 0 (reserved), 1 (indicating that electronic device 110-2 supports battery reporting), 2 (indicating that electronic device 110-2 is docked or powered), 3 (indicating that electronic device 110-2 supports Siri status reporting), and 4 (indicating that electronic device 110-2 supports noise-reduction or NR status reporting).

An example of this command is AT+XAPL=ABCD-1234-0100-24 (i.e., electronic device 110-2 is docked or powered and supports NR status). In response, electronic device 110-1 may communicate the command+XAPL=iPhone, [features].

Note that electronic device 110-2 may send this command after a successful HFP service level connection (SLC) to electronic device 110-1 in order to receive Siri status events. Moreover, electronic device 110-2 may send the AT+XAPL command before sending any Siri-specific commands, as explained in the following discussion.

After establishing the HFP connection, the remote command interface facilitated by the program module may allow electronic device 110-2 to obtain information on the Siri availability of electronic device 110-1 and an update on the Siri status/capability using the HFP Command AT+APLSIRI?. This status information may be provided if Siri is enabled on electronic device 110-1. This command functionality may also provide the ability for electronic device 110-2 to receive information about changes in the Siri status.

In response to this command, electronic device 110-1 may communicate the command +APLSIRI: <value>. An example of this command is +APLSIRI: 1. Note that the defined values may include: 0 (indicating that Siri is not available on this platform), 1 (indicating that Siri is available and enabled), and 2 (indicating that Siri is available and is not enabled).

To receive Siri status from electronic device 110-1, the HFP Command AT+APLSIRI may be used. This command is an unsolicited event indicating a change in Siri status. It may be initiated by electronic device 110-1. The command format is +APLSIRI: <value>. An example of this command is +APLSIRI: 2. Note that the defined values may include: 1 (indicating that Siri is available and enabled), and 2 (indicating that Siri is available and is not enabled). The Siri status update may be provided by electronic device 110-1 if there is a change in the status, or if electronic device 110-2 has requested the Siri status (using the HFP command AT+APLSIRI?) at least once after the connection was established and if Siri support is enabled.

Electronic device 110-2 can also remotely start or initiate a Siri session. In particular, electronic device 110-2 may use an HFP voice-recognition command (AT+BVRA). A precondition for this command is that HFP profile is connected and the SLC exists. The sequence for this command is as follows: electronic device 110-2 sends the command AT+BVRA=1 to electronic device 110-1; electronic device 110-1 responds AT+OK; then electronic device 110-1 launches a Siri session and creates a synchronous-connection-oriented (SCO) link or connection for audio; once the Siri session is completed, electronic device 110-1 sends the command +BVRA: 0 to electronic device 110-2; and electronic device 110-1 disconnects the SCO link.

Alternatively, a Siri session may be started from electronic device 110-1. In this case, if the voice-recognition command is supported by electronic device 110-2, electronic device 110-1 may use the command AT+BVRA to indicate the start of a Siri session. The sequence for this command is as follows: electronic device 110-1 sends the +BVRA: 1 command to electronic device 110-2; then, electronic device 110-1 launches the Siri session and creates an SCO link for audio; once the Siri session is completed, electronic device 110-1 sends the command +BVRA: 0 to electronic device 110-2; and electronic device 110-1 disconnects the SCO link.

The commands and information may also be used to provide suggestions as to how to improve the voice-recognition performance, and in particular, the quality of the audio coming from electronic device 110-2. In general, NR processing (which involves modifying an audio signal to improve its quality and to make it more intelligible) of the audio coming from electronic device 110-2 to electronic device 110-1 may be turned off during a Sin session. However, filtering of the audio signal to remove echo or feedback noise may be used. In some embodiments, electronic device 110-2 may optimize NR processing for voice recognition rather than for speech quality. Additionally, electronic device 110-2 may provide an accurate state of the audio processing in the input data to electronic device 110-1. Note that the signal-to-noise ratio may be between 15 to 20 dB, and that 16 kHz wideband speech audio may provide better audio quality and voice-recognition performance by Siri of the input audio from electronic device 110-2.

To obtain information about the state of audio coming from electronic device 110-2 (and, in particular, the NR status), electronic device 110-1 may use the HFP command AT+APLNRSTAT. Similarly, electronic device 110-2 may send this command to notify electronic device 110-1 about the state of incoming audio from electronic device 110-2 during the Siri session. The format of this command is AT+APLNRSTAT=<value>. An example of this command is AT+APLNRSTAT=1. Note that defined values may include: 1 (indicating that audio processing is enabled on input audio and can be disabled); 2 (indicating that audio processing is enabled on input audio and cannot be disabled); 3 (indicating that audio processing is not enabled on input audio and can be enabled); and 4 (indicating that audio processing is not enabled on input audio and cannot be enabled). The response from electronic device 110-1 may be AT+OK.

This command may be used by electronic device 110-1 to characterize the input audio coming from electronic device 110-2 during a Siri session. This information may be received once after a successful HFP SLC connection. If the state subsequently changes, then updated information may also be requested.

In addition, the HFP command AT+APLNRSTAT may be used by electronic device 110-1 during a Siri session to disable NR processing of input speech audio (for example, provided by a user of electronic device 110-2) by electronic device 110-2. This change may remain active for the duration of an SCO link. However, once the SCO link is disconnected, electronic device 110-2 may reset to its default NR state. The command format is +APLNRSTAT: <value>. An example of this command is +APLNRSTAT: 0. Note that defined values may include: 0 (indicating disable NR processing) and 1 (indicating enable NR processing).

In some embodiments, electronic device 110-2 can control the Siri responses that include display information (which is sometimes referred to as a Siri ‘eyes-free mode’) using the HFP command AT+APLEFM. This modified presentation operation mode of electronic device 110-1 allows electronic device 110-2 to limit Siri responses that include display information (such that the responses are provided using an audio signal with limited or no display information instead). Thus, electronic device 110-2 can enable/disable this modified presentation operation mode if needed. For example, electronic device 110-2 may transition electronic device 110-1 into the modified presentation operation mode when the user is driving (for example, in a car).

The command format is AT+APLEFM=<value>. An example of this command is AT+APLEFM=1. Note that defined values may include: 0x00 (indicating disable eyes-free mode); 0x01 (indicating enable eyes-free mode); and 0x02-0xFF (which are reserved). Electronic device 110-1 may response with AT+OK.

As noted above, this command may be used by electronic device 110-1 to modify the Siri responses that include display information. Moreover, suitable audio feedback may be provided to the user depending on the Siri command initiated. Once electronic device 110-2 has set the eyes-free mode, it may remain set for all subsequent Sin sessions until electronic device 110-2 disables it or the connection is disconnected.

We now describe embodiments of the electronic device. FIG. 3 presents a block diagram illustrating an electronic device 300. This electronic device includes processing subsystem 310, memory subsystem 312, and networking subsystem 314. Processing subsystem 310 includes one or more devices configured to perform computational operations. For example, processing subsystem 310 can include one or more microprocessors, application-specific integrated circuits (ASICs), microcontrollers, programmable-logic devices, and/or one or more digital signal processors (DSPs).

Memory subsystem 312 includes one or more devices for storing data and/or instructions for processing subsystem 310 and networking subsystem 314. For example, memory subsystem 312 can include dynamic random access memory (DRAM), static random access memory (SRAM), and/or other types of memory. In some embodiments, instructions for processing subsystem 310 in memory subsystem 312 include: one or more program modules or sets of instructions (such as program module 322 or application 324), which may be executed by processing subsystem 310. Note that the one or more computer programs may constitute a computer-program mechanism. Moreover, instructions in the various modules in memory subsystem 312 may be implemented in: a high-level procedural language, an object-oriented programming language, and/or in an assembly or machine language. Furthermore, the programming language may be compiled or interpreted, e.g., configurable or configured, to be executed by processing subsystem 310.

In addition, memory subsystem 312 can include mechanisms for controlling access to the memory. In some embodiments, memory subsystem 312 includes a memory hierarchy that comprises one or more caches coupled to a memory in electronic device 300. In some of these embodiments, one or more of the caches is located in processing subsystem 310.

In some embodiments, memory subsystem 312 is coupled to one or more high-capacity mass-storage devices (not shown). For example, memory subsystem 312 can be coupled to a magnetic or optical drive, a solid-state drive, or another type of mass-storage device. In these embodiments, memory subsystem 312 can be used by electronic device 300 as fast-access storage for often-used data, while the mass-storage device is used to store less frequently used data.

Networking subsystem 314 includes one or more devices configured to couple to and communicate on a wired and/or wireless network (i.e., to perform network operations), including: control logic 316, an interface circuit 318 and an antenna 320. For example, networking subsystem 314 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 300 may use the mechanisms in networking subsystem 314 for performing simple wireless communication between the electronic devices, e.g., transmitting advertising frames and/or scanning for advertising frames transmitted by other electronic devices as described previously.

Within electronic device 300, processing subsystem 310, memory subsystem 312, and networking subsystem 314 are coupled together using bus 328. Bus 328 may include an electrical, optical, and/or electro-optical connection that the subsystems can use to communicate commands and data among one another. Although only one bus 328 is shown for clarity, different embodiments can include a different number or configuration of electrical, optical, and/or electro-optical connections between the subsystems.

In some embodiments, the electronic device includes a display subsystem 326 for displaying information on a display, which may include a display driver and the display, such as a liquid-crystal display, a touchscreen, etc.

Electronic device 300 can be (or can be included in) any electronic device with at least one network interface. For example, electronic device 300 can be (or can be included in): a desktop computer, a laptop computer, a server, a media player (such as an MP3 player), an appliance, a subnotebook/netbook, a tablet computer, a smartphone, a cellular telephone, a piece of testing equipment, a network appliance, a set-top box, a personal digital assistant (PDA), a toy, a controller, a digital signal processor, a game console, a computational engine within an appliance, a consumer-electronic device, a portable computing device, a personal organizer, and/or another electronic device.

Although specific components are used to describe electronic device 300, in alternative embodiments, different components and/or subsystems may be present in electronic device 300. For example, electronic device 300 may include one or more additional processing subsystems 310, memory subsystems 312, networking subsystems 314, and/or display subsystems 326. Additionally, one or more of the subsystems may not be present in electronic device 300. Moreover, in some embodiments, electronic device 300 may include one or more additional subsystems that are not shown in FIG. 3. For example, electronic device 300 can include, but is not limited to, a data collection subsystem, an audio and/or video subsystem, an alarm subsystem, a media processing subsystem, and/or an input/output (I/O) subsystem. Also, although separate subsystems are shown in FIG. 3, in some embodiments, some or all of a given subsystem or component can be integrated into one or more of the other subsystems or component(s) in electronic device 300. For example, in some embodiments program module 322 is included in application 324.

Moreover, the circuits and components in electronic device 300 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 314, such as a radio. Moreover, the integrated circuit may include hardware and/or software mechanisms that are used for transmitting wireless signals from electronic device 300 (FIG. 3) and receiving signals at electronic device 300 from other electronic devices (FIG. 3). Aside from the mechanisms herein described, radios are generally known in the art and hence are not described in detail. In general, networking subsystem 314 (FIG. 3) and/or the integrated circuit can include any number of radios. Note that the radios in multiple-radio embodiments function in a similar way to the described single-radio embodiments.

In some embodiments, networking subsystem 314 (FIG. 3) and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, etc.)

While Bluetooth™ was used as an illustrative example, the described embodiments of the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna;
an interface circuit, coupled to the antenna, configured to communicate with another electronic device using a connection;
a processor; and
memory, wherein the memory stores an application and a program module, and wherein the program module is configurable to be executed by the processor to facilitate remote interaction between the other electronic device and the application, the program module including:
instructions for receiving a command from the interface circuit, wherein the command was received by the interface circuit from the other electronic device via the connection, and wherein the command includes one of: starting the application, turning off the application, and transitioning the application to a modified presentation operation mode; and
instructions for executing the command.

2. The electronic device of claim 1, wherein the application includes an intelligent personal assistant and knowledge manager.

3. The electronic device of claim 1, wherein the application includes Siri.

4. The electronic device of claim 1, further comprising a display, wherein, in the modified presentation operation mode, the application limits information presented on display.

5. The electronic device of claim 1, wherein the program module further includes instructions for receiving configuration information from the interface circuit;
wherein the configuration information was received by the interface circuit from the other electronic device via the connection; and
wherein the configuration information includes a noise-reduction status of information communicated by the other electronic device via the connection.

6. The electronic device of claim 5, wherein the program module further includes instructions for providing a modification to the configuration information to the interface circuit for transmission to the other electronic device; and
wherein the modification is based on the received configuration information and a performance of the connection.

7. The electronic device of claim 1, wherein the connection uses a Bluetooth™ communication protocol.

8. The electronic device of claim 1, wherein the electronic device includes a portable electronic device.

9. A computer-program product for use in conjunction with an electronic device, the computer-program product comprising a non-transitory computer-readable storage medium and a computer-program mechanism embedded therein, to facilitate remote interaction between another electronic device and an application on the electronic device, the computer-program mechanism including:
instructions for receiving a command from an interface circuit in the electronic device, wherein the command was received by the interface circuit from the other electronic device via a connection, and wherein the command includes one of: starting the application, turning off the application, and transitioning the application to a modified presentation operation mode; and
instructions for executing the command.

10. The computer-program product of claim 9, wherein the application includes an intelligent personal assistant and knowledge manager.

11. The computer-program product of claim 9, wherein the application includes Siri.

12. The computer-program product of claim 9, wherein, in the modified presentation operation mode, the application limits information presented on a display in the electronic device.

13. The computer-program product of claim 9, wherein the computer-program mechanism further includes instructions for receiving configuration information from the interface circuit;
wherein the configuration information was received by the interface circuit from the other electronic device via the connection; and
wherein the configuration information includes a noise-reduction status of information communicated by the other electronic device via the connection.

14. The computer-program product of claim 13, wherein the computer-program mechanism further includes instructions for providing a modification to the configuration information to the interface circuit for transmission to the other electronic device; and
wherein the modification is based on the received configuration information and a performance of the connection.

15. The computer-program product of claim 9, wherein the connection uses a Bluetooth™ communication protocol.

16. A method for remote interaction between electronic devices, wherein the method comprises:
receiving a command from another electronic device via a connection using an interface circuit on an electronic device, wherein the command includes one of: starting an application on the electronic device, turning off the application, and transitioning the application to a modified presentation operation mode;
providing the command from the interface circuit to a program module; and
executing the command.

17. The method of claim 16, wherein the application includes an intelligent personal assistant and knowledge manager.

18. The method of claim 16, wherein the application includes Siri.

19. The method of claim 16, wherein, in the modified presentation operation mode, the application limits information presented on a display in the electronic device.

20. The method of claim 16, wherein the method further comprises receiving configuration information from the interface circuit;
wherein the configuration information was received by the interface circuit from the other electronic device via the connection; and
wherein the configuration information includes a noise-reduction status of information communicated by the other electronic device via the connection.

21. The method of claim 20, wherein the method further comprises providing a modification to the configuration information to the interface circuit for transmission to the other electronic device; and
wherein the modification is based on the received configuration information and a performance of the connection.
